(19) United States
(12) Patent Application Publication
(10) Pub. No.: US 2005/0007596 A1
(43) Pub. Date: Jan. 13, 2005

(54) Apparatus and method for increasing the sensitivity of in-line infrared sensors

(75) Inventors: Paul A. Wilks JR., Darien, CT (US); Michael Edward Glowinski, Ridgefield, CT (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Wilks Enterprise, Inc.

(21) Appl. No.: 10/617,611

(22) Filed: Jul. 11, 2003

(51) Int. Cl. G01N 21/17

(52) U.S. Cl. 356/436; 250/353

(57) ABSTRACT

A slot is interposed within an optical element to intercept a radiation path to increase the sensitivity of an in-line infrared sensor. The slot is perpendicular to the radiation path. The optical element is insertable directly in a process stream to determine an amount of absorption of a sample in the process stream. The optical element has a truncated cone or prism shape. Another method for increasing the sensitivity of an in-line infrared sensor comprises placing a prism in contact with a base of an optical element capable of causing a beam originating from a source to be internally reflected at least twice though the optical element and terminate at a detector. The optical element is placed in a process stream. The prism, source, and detector are ninety degrees apart from each other and in contact with the base.

### BACKGROUND

1. Field of the Invention

The present invention generally relates to in-line infrared sensors. In particular, it relates to increasing the sensitivity of in-line infrared sensors by transmission and internal reflection.

2. Description of the Related Art

Some applications of infrared sensors require increased sensitivity to detect small concentrations, such as water in acetone, which is a critical measurement in the chemical processing industry. Raw materials used to make plastics need to be totally free of water to avoid interference with chemical processes. There is a need for sampling procedures with enough sensitivity to detect small concentrations, such as 50 parts per million of water in acetone.

The old fashioned way requires taking the sample off-line and to a laboratory and then putting it back in-line. Laboratory instruments are used to put the sample through an absorption cell that has two windows close together so that infrared energy passes through it. These procedures are often complicated. It could take as long as five hours. In the meantime, the product stream has produced a lot of bad product. There is a need for a more direct method where measurements can be made in-line (in-situ).

In-situ optical sensors are installed in process streams to measure the concentration of a component in the stream by means of the absorption of infrared radiation at a specific wavelength absorbed by that component. In the conventional optical design, absorption takes place at locations on the optical element where internal reflection occurs. Optical elements have been constructed varying from 2 to 9 internal reflections. The amount of absorption is a function of the depth of penetration of the beam at the reflection location times the number of reflections.

The depth of penetration that occurs at each reflection point is determined by the angle of the beam at that point and the relative indices of refraction of the optical material and the medium in contact with it. Typically the penetration or effective pathlength is one to two microns per reflection. When the concentrations of the component to be measured are one percent or more, these pathlengths with 3 to 5 reflections produce sufficient absorption for accurate concentration computation. However, these pathlengths are not long enough to yield sufficient absorption to measure concentrations in the lower ranges of less than one percent or low parts per million.

In the laboratory, absorption cells are constructed from two windows separated by a spacer to provide the required transmission pathlength. Such cells cannot be inserted directly into a process stream to monitor low concentrations. To achieve the necessary effective pathlengths, it is generally necessary to take a slip stream off the main process line to pass through the external cell. Another method is to pass radiation through a bundle of optical fibers that are inserted into a process stream and another bundle placed so that is collects the energy coming out of the end of the first bundle with a suitable gap that acts as a transmission cell and returns it to the measuring device. Optical fibers tend to be inefficient in energy transmission especially in the mid infrared range beyond two micro meters wavelength. It is in the five to fifteen micro meter region that the most important absorption bands occur.

There is a need for a method to increase the effective pathlength of the in-line sensor optical element, while retaining its ability to function within the process stream. This would eliminate the need for expensive and inefficient optical fibers and lightpipes.

### SUMMARY OF THE INVENTION

A slot is interposed within an optical element to intercept a radiation path to increase the sensitivity of an in-line infrared sensor. The slot is perpendicular to the radiation path. The optical element is insertable directly in a process stream to determine an amount of absorption of a sample in the process stream. The optical element has a truncated cone or prism shape.

Another method for increasing the sensitivity of an in-line infrared sensor comprises placing a prism in contact with a base of an optical element capable of causing a beam originating from a source to be internally reflected at least twice though the optical element and terminate at a detector. The optical element is placed in a process stream. The prism, source, and detector are ninety degrees apart from each other and in contact with the base.

An in-line infrared sensor having increased sensitivity comprises an optical element having a slot. The slot is capable of intercepting a beam between internal reflection points of the optical element. The optical element is insertable directly in a process stream so that radiation is absorbed by a sample in contact with the slot. The optical element has a truncated cone shape. The slot is perpendicular to the beam.

An in-line infrared sensor having increased sensitivity comprises an optical element having a base. A prism is in contact with the base. A source is in contact with the base and ninety degrees away from the prism. A detector is in contact with the base and ninety degrees away from both the source and the prism. A beam originates from the source, passes twice through the optical element, and terminates at the detector. The optical element is insertable directly in a process stream to determine an amount of absorption of a sample in the process stream. The optical element has a truncated cone shape and a sixty degree face. The prism has a forty-five degree face.

These and other features, aspects, and advantages of the present invention will become better understood with reference to the following drawings, description, and appended claims.

### BRIEF DESCRIPTION OF THE DRAWINGS

FIG. 1 is a sectional view of a prior art optical element with two reflection points.

FIG. 2 is a sectional view of a prior art optical element with three reflection points.

FIG. 3 is a sectional view of an optical element with a slot in the top according to the present invention.

FIG. 4 is a sectional view of an optical element with a slot in a side face according to the present invention.

FIG. 5 is a top view of an optical element with a prism according to the present invention.

FIG. 6 is a side view of the optical element with the prism in FIG. 5.

FIG. 7 is a three-dimensional rendering of the optical element with the prism in FIGS. 5 and 6.

### DETAILED DESCRIPTION OF THE PREFERRED EMBODIMENTS

In the following detailed description, reference is made to the accompanying drawings. These drawings form a part of this specification and show, by way of example, specific preferred embodiments in which the present invention may be practiced. These embodiments are described in sufficient detail to enable those skilled in the art to practice the present invention. Other embodiments may be used. Structural, logical, and electrical changes may be made without departing from the spirit and scope of the present invention. Therefore, the following detailed description is not to be taken in a limiting sense and the scope of the present invention is defined only by the appended claims.

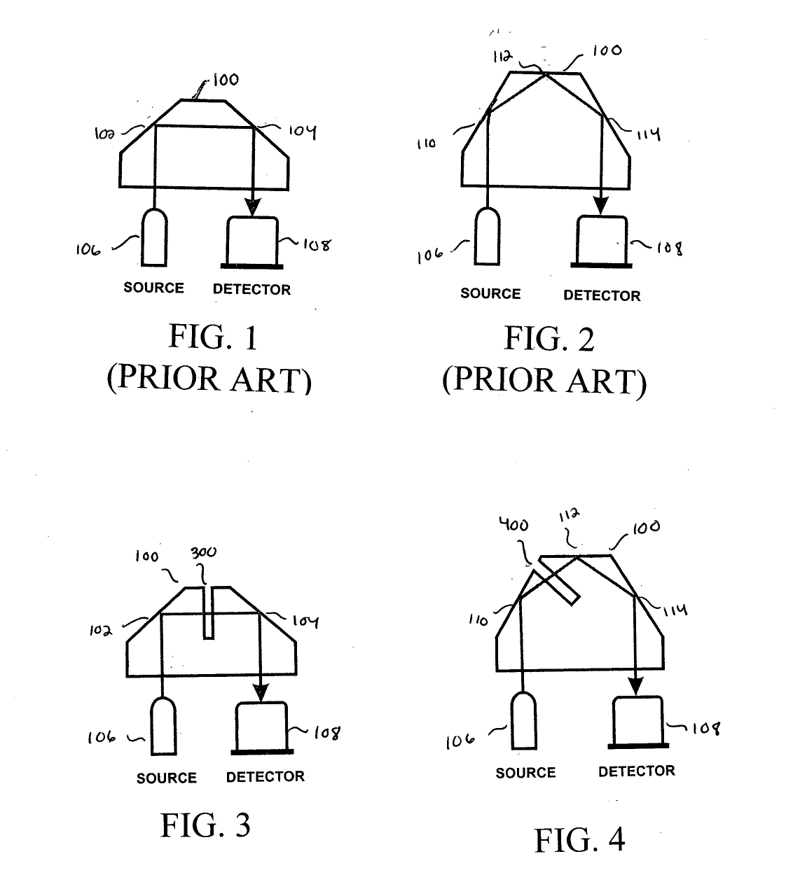

FIGS. 1 and 2 show conventional optical elements 100, which are attenuated total reflection (ATR) optical elements. Optical element 100 has two reflection points 102 and 104. A source 106 and a detector 108 are also shown. Source 106 is a lamp, such as a hot filament or a tungsten lamp that radiates energy in a spectral region for a particular measurement. Detector 108 may be any kind of detector, such as a thermopile pyroelectric detector, or lead solenoid detectors. For example, a detector may have a window to pass a particular wavelength in an particular absorption band to measure the amount of energy at that particular wavelength that was eliminated from the radiation beam by the presence of a particular substance. From this measurement, a concentration of the substance can be determined. The optical element in FIG. 2 has three reflection points 110, 112, and 114. Conventional ATR optical elements are converted into embodiments of the present invention by inserting a slot at an appropriate position within the optical elements as shown in FIGS. 3 and 4.

FIG. 3 shows optical element 100 with a slot 300 in the top, while FIG. 4 shows optical element 100 with a slot 400 in a side face. Optical element 100 preferably has a truncated cone shape. This circular shape is easier to seal and place in a holder than a rectangular one. In FIG. 3, infrared absorption takes place both at the reflection points 102 and 104 and when the beam passes through the slot 300. In FIG. 4, infrared absorption takes place both at the reflection points 110, 112, and 114 and when the beam passes through the slot 400. The width of the slot varies depending on the requirements for an effective pathlength for each specific application.

In FIG. 3, the internal reflection effect occurs when a beam of radiation passes into a material that transmits infrared radiation. It is reflected internally if the angle where it strikes the next surface at reflection point 102 is greater than the critical angle, which is a function of the indexes of refraction of the crystal material and the sample that is in contact with it. Optical element 100 comprises any optically transparent material, for example, sapphire or cubic zirconia. The critical angle for sapphire is less than 60 degrees and for cubic zirconia it is less than 45 degrees with a typical organic liquid stream. The beam goes into optical element 100, strikes a surface at reflection point 102 goes across to a second surface at reflection point 104 and then back out onto detector 108. Slot 300 is interposed where the beam traverses from one surface to another, which gives an area where the sample can fill slot 300 and infrared radiation passing through slot 300 is absorbed. As a result, the concentration of a substance in the sample can be determined. Making slot 300 thicker increases sensitivity, but there is a limit to its thickness because of background absorption in the material (e.g., acetone) containing the substance being measured (e.g., water). Slot 300 is selected to give the best sensitivity for the desired measurement.

One application of an infrared in-line sensor is measuring very small concentrations of water in a solvent such as acetone. The example test results below (in arbitrary absorption units) illustrate poor sensitivity for an unslotted crystal and increased sensitivity for both a crystal with a 0.013″ slot and a crystal with a 0.030″ slot.

| ppm Water in | Unslotted | | |
|---|---|---|---|
| Acetone | Crystal | 0.013″ Slot | 0.030″ Slot |
| 1000 | 1 | 22 | 53 |
| 100 | 0 | 8 | 19 |
| 10 | 0 | 0 | 20 |

Another application among many is monitoring dissolved carbon dioxide in water and brix (sugar) in the beverage industry. It is advantageous to combine internal reflection and transmission to increase sensitivity in infrared absorption measurements.

In addition to using an optical element with a slot, combining an optical element with a prism is another way to increase sensitivity.

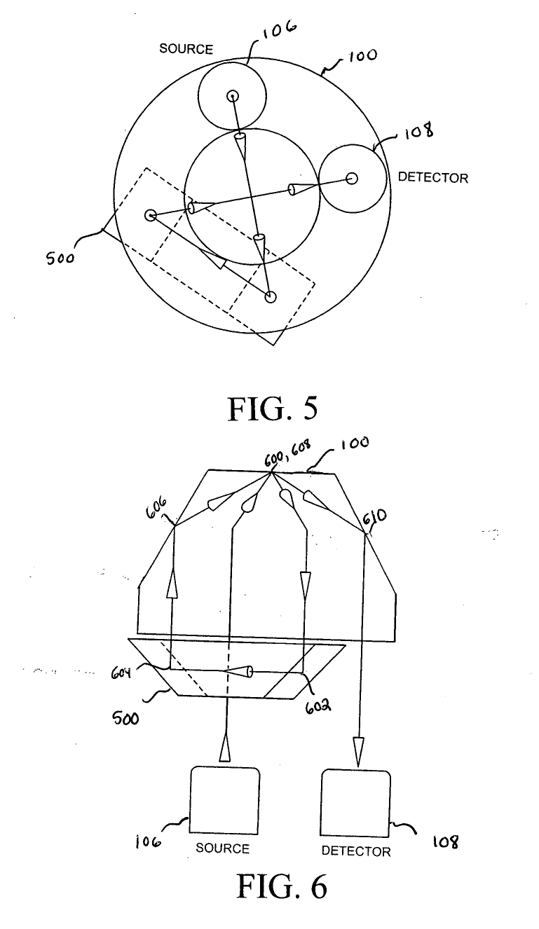

FIG. 5 shows a top view of an optical element 100 with a prism 500 according to the present invention as well as a source 106 and a detector 108. Optical element preferably has a 60 degree face. A radiation beam originates from source 106 reflects within optical element 100 and then to prism 500, which reflects the beam back into optical element 100 and then to detector 108.

Prism 500 is any kind of prism, preferably having two faces that are 45 degrees to the base, such as a trapezoid shaped prism or a dove prism. Prism 500 takes the beam as it exits optical element 100 and reflects it in such a way that it goes across the 90 degree movement and then the beam is sent back into optical element 100. Then it goes across at right angles to the original beam and strikes detector 108. Detector 108 is 90 degrees away from source 106 and 180 degrees away from an end of prism 500. Thus, prism 500 increases the number of reflections. Each reflection produces infrared absorption so if, for example, there are six reflections, there is twice the sensitivity of a three-reflection system. The more reflection points, the greater the sensitivity.

FIG. 6 shows a side view of the same optical element 100 with prism 500 as in FIG. 5. The radiation beam in this example has six reflection points 600, 602, 604, 606, 608, and 610 in that order along the transmission path between source 106 and detector 108. Prism 500 reflects the beam back into optical element 100 after reflection point 604. The present invention contemplates various transmission paths and various numbers of reflection points.

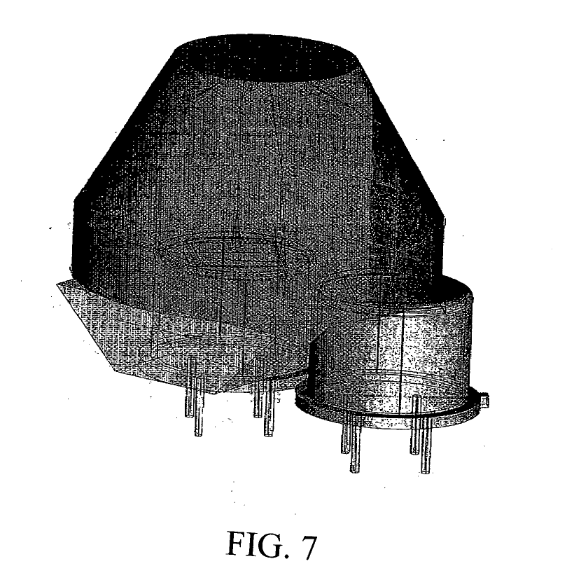

FIG. 7 shows a three-dimensional rendering of optical element 100 with prism 500, source 106, and detector 108 in FIG. 6. In FIGS. 1-4 and 6, source 106 and detector 108 were shown at a distance for clarity. As shown in FIG. 7, source 106 and detector 108 are actually in contact with a base of optical element 100. Prism 500 is also in contact with the base. Prism 500, source 106, and detector 108 are ninety degrees away from each other in one embodiment. Preferably, the bottom of optical element 100 is flat and source 106 and detector 108 are in contact with the bottom in locations where the beam comes in and out.

An example embodiment, providing an intermediate effective path length by doubling the number of internal reflections, is achieved by placing a dove prism in contact with the base of the truncated cone. The light path can be rotated by 90° and second series of three reflections can be caused to occur before the light reaches the detector. Such an intermediate path length is important when the sample is aqueous or of high viscosity, where the slotted cone provides too much absorption for water based samples, or too much impediment to viscous samples.

It is to be understood that the above description is intended to be illustrative and not restrictive. Many other embodiments will be apparent to those of skill in the art upon reviewing the above description, such as adaptations of the present invention to chemical engineering applications. Various types of infrared sensors are contemplated by the present invention, even though some minor elements would need to change to better support variations. The present invention has applicability to fields outside industry applications, such as chemical processes and other procedures. Therefore, the scope of the present invention should be determined with reference to the appended claims, along with the full scope of equivalents to which such claims are entitled.

1. A method for increasing the sensitivity of an in-line infrared sensor, comprising:
interposing a slot within an optical element to intercept a radiation path, said slot being perpendicular to said radiation path; and
inserting said optical element directly in a process stream to determine an amount of absorption of a sample in said process stream.

2. The method according to claim 1, wherein said optical element has a truncated cone shape.

3. A method for increasing the sensitivity of an in-line infrared sensor, comprising:
placing a prism in contact with a base of an optical element capable of causing a beam originating from a source to be internally reflected at least twice though said optical element and terminate at a detector; and
placing said optical element in a process stream.

4. The method according to claim 3, wherein said prism, said source, and said detector are ninety degrees apart from each other and in contact with said base.

5. An in-line infrared sensor having increased sensitivity, comprising:
an optical element having a slot capable of intercepting a beam between internal reflection points of said optical element;
wherein said optical element is insertable directly in a process stream so that radiation is absorbed by a sample in contact with said slot.

6. The in-line infrared sensor according to claim 5, wherein said optical element has a truncated cone or prism shape.

7. The in-line infrared sensor according to claim 5, wherein said slot is perpendicular to said beam.

8. An in-line infrared sensor having increased sensitivity, comprising:
an optical element having a base;
a prism in contact with said base;
a source in contact with said base and ninety degrees away from said prism; and
a detector in contact with said base and ninety degrees away from both said source and said prism;
wherein a beam originates from said source, passes twice through said optical element, and terminates at said detector.

9. The in-line infrared sensor according to claim 8, wherein said optical element is insertable directly in a process stream to determine an amount of absorption of a sample in said process stream.

10. The in-line infrared sensor according to claim 8, wherein said optical element has a truncated cone shape.

11. The in-line infrared sensor according to claim 8, wherein said optical element has a sixty degree face.

12. The in-line infrared sensor according to claim 8, wherein said prism has a forty-five degree face.
